(19) United States
(12) Patent Application Publication
(10) Pub. No.: US 2021/0384580 A1
(43) Pub. Date: Dec. 9, 2021

(54) SYSTEM FOR MOBILIZING BATTERIES OF A VEHICLE

(71) Applicant: Harrison Powell, Naples, FL (US)

(72) Inventor: Harrison Powell, Naples, FL (US)

(21) Appl. No.: 17/230,552

(22) Filed: Apr. 14, 2021

Related U.S. Application Data
(60) Provisional application No. 63/036,373, filed on Jun. 8, 2020.

(51) Int. Cl. H01M 50/249; B60K 1/04; H01M 50/242; G07C 5/08

(52) U.S. Cl. CPC H01M 50/249; G07C 5/085; H01M 50/242; B60K 1/04

(57) ABSTRACT

A system and method for mobilizing batteries of a vehicle to increase efficiency, performance, and safety is provided. The system generally comprises a battery, frame, track, drive, processor, and non-transitory computer-readable medium having instructions stored thereon. The system may calculate position data and manipulate the battery's position within the frame using the position data. A computing device having position data stored therein may be used by a user to change the position of the batteries. Alternatively, the system may use at least one sensor to obtain environmental data, which the system may use to generate position data and manipulate the position of the battery in real time.

### CROSS-REFERENCE TO RELATED APPLICATIONS

The present invention claims priority to provisional application, Ser. No. 63/036,373 filed Jun. 8, 2020 entitled “SYSTEM FOR MOBILIZING BATTERIES OF A VEHICLE” which is hereby incorporated in its entirety at least by reference.

### BACKGROUND OF THE INVENTION

### 1. Field of the Invention

The subject matter of the present disclosure refers generally to a system and method for mobilizing batteries of a vehicle to increase efficiency, performance, and safety.

### 2. Description of Related Art

Many modern electric vehicles have large batteries, which are needed to provide power to the electric engines. However, there is an increasing consensus that increasing the size of the batteries within electric vehicles may have disadvantages that outweigh the benefits. For example, electric vehicles are already too costly for many consumers, and increasing battery size only increases the cost, since batteries are one of the most expensive pieces of equipment in an electric vehicle. Additionally, in order to offset the added mass from the larger battery size, lighter weight materials would have to be used to build the rest of the vehicle, which further increases the cost to the end consumer.

Further, larger batteries would also require additional protective structural features for the batteries due to the explosive nature of some batteries when a cell is damaged. The increased weight from these systems will also require more robust support systems, such as braking, suspension, etc., further increasing the cost to the end user.

Therefore, though the range of an electric vehicle can be increased by increasing the battery size, the efficiency of the vehicle ultimately remains more or less the same, meaning the cost per mile to drive the electric vehicle ultimately goes up due to the increase cost to purchase an electric vehicle with a larger battery size. The larger battery size combined with the aforementioned required additional structural features can also greatly decrease the amount of cargo space within the vehicle, decreasing the overall comfort level of the driver. Current solutions for increasing the range of electric vehicles that do not involve increasing the battery size include methods such as regenerative braking, higher efficiency inverters, and increasing the network of charging stations available to electric vehicles. While these systems can/do increase the range of electric vehicles, they do not use the vehicles center of mass to increase the efficiency, which can change depending on the battery size. For the purposes of this disclosure center of mass or center of gravity may be used interchangeably.

Accordingly, there is a need in the art for a system that scales with size to actively redistribute the weight of batteries in electric vehicles to increase efficiency, performance, and safety.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide a system for mobilizing a battery of a vehicle to increase efficiency, performance, and safety.

In order to do so, in one aspect of the invention, a system for mobilizing a battery of a vehicle is provided, the system comprising a frame; a track operably connected to the frame; a battery attached to the track; and, a drive operably connected to the battery via a connection element, wherein the drive is configured to alter a position of the battery relative to the frame such that the vehicle's center of mass is altered in real time.

In one embodiment, the drive comprises an electric engine, a pneumatic device, or a hydraulic device. In one embodiment, the connection element is a cable or strut. In another embodiment, the system further comprises at least one sensor configured to record and transmit environmental data; a processor operably connected to the drive and the at least one sensor, wherein the processor is configured to calculate position data using the environmental data, wherein the processor is configured to direct the drive in a way that moves the battery to a position that coincides with the position data; a computing device having instructions and operably connected to the processor, wherein said instructions contain position data that may be used to move the battery to the position; and, wherein a user may choose the instructions using a user interface of the computing device. In yet another embodiment, the vehicle is a car, a truck, a train, an airplane, a helicopter, a motorcycle, a bike, a utility vehicle, an all-terrain vehicle, a farm equipment vehicle, a crane, or a boat.

In another aspect of the invention, a system for mobilizing a battery of a vehicle is provided, comprising a frame; a track operably connected to the frame, wherein the track is configured to move about the frame along a first axis; a battery attached to the track such that the battery is configured to move along the first axis; and, a drive operably connected to the battery via a connection element, wherein the drive is configured to alter a position of the battery relative to the frame along a second axis such that the vehicle's center of mass is altered in real time increasing the performance and handling of the vehicle.

In one embodiment, the second axis intersects the first axis. In another embodiment, the second axis is perpendicular to the first axis.

In yet another aspect of the invention, a method for mobilizing a battery of a vehicle is provided, comprising steps (a) obtaining a vehicle having a battery mobilization device, the battery mobilization device having a frame, a track operably connected to the frame, a battery attached to the track, and a drive operably connected to the battery; (b) determining a preferred position of the battery coinciding with a center of mass of the vehicle; and, (c) changing a position of the battery within the frame using the drive until the preferred position of the battery is accomplished.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 illustrates a perspective view of a system for mobilizing batteries of a vehicle according to an embodiment of the present invention;

FIG. 2 illustrates a perspective view of a system for mobilizing batteries of a vehicle according to an embodiment of the present invention;

FIG. 3 illustrates a perspective view of a system for mobilizing batteries of a vehicle according to an embodiment of the present invention;

FIG. 4 illustrates the system installed on a vehicle according to an embodiment of the present invention;

FIG. 5 illustrates the system installed on a vehicle according to an embodiment of the present invention; and,

FIG. 6 illustrates a flow chart of a method for mobilizing batteries of a vehicle according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a system for mobilizing batteries of a vehicle.

As used in this application, the term “a” or “an” means “at least one” or “one or more.” As used in this application, the term “about” or “approximately” refers to a range of values within plus or minus 10% of the specified number. As used herein, the singular forms “a,” “an,” and “the” include plural references unless the context clearly dictates otherwise. Any reference to “or” herein is intended to encompass “and/or” unless otherwise stated. As used herein, the term “about” refers to an amount that is near the stated amount by about 0%, 5%, or 10%, including increments therein. Unless otherwise defined, all technical terms used herein have the same meaning as commonly understood by one of ordinary skill in the art to which this disclosure belongs.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). The term “position data” and grammatical equivalents thereof are used herein to mean coordinates located on axes within the shape created by the frame of the system, wherein the battery of the system may be moved to a position within the shape created by the frame that coincides with said coordinates. For instance, the system may use position data to move the batteries to a position that coincides with coordinates of defined X, Y, and Z axes within the shape created by the frame.

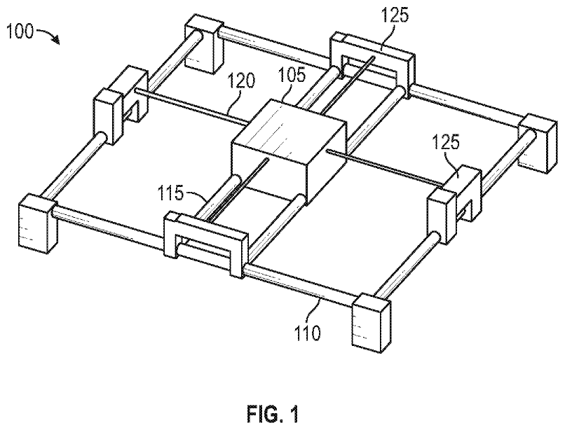

Turning now to the drawings, FIGS. 1-6 illustrate preferred methods of use and embodiments of a system 100, or certain components thereof, for mobilizing the batteries 105 within a vehicle 130. The system 100 generally comprises a battery 105, frame 110, track 115, drives 125, processor, and non-transitory computer-readable medium having instructions stored thereon, wherein the instructions instruct the processor to perform a specific task or group of tasks that allow the system 100 to manipulate the battery's 105 position within the frame 110. Other preferred embodiments of the system 100 may further comprise a geolocation device and/or computing device that may be used by the system 100 to alter the battery's 105 position within the frame 110.

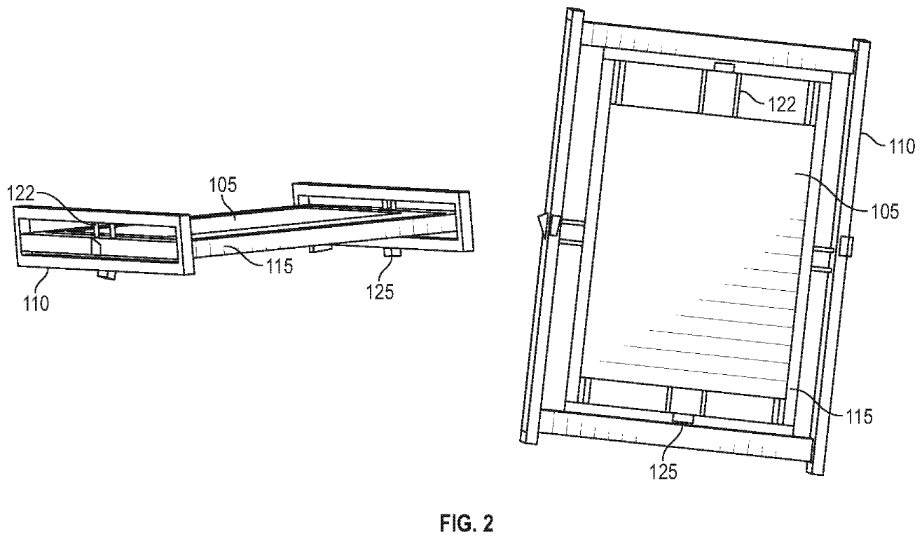

In a preferred embodiment, as illustrated in FIGS. 1 and 2, the track 115 is operably connected to the frame 110 in a way such that it may move about the frame 110. The battery 105 sits within the track 115 and may be manipulated about the same axis as the track 115. The battery 105 may also be operably connected to the track 115 in a way such that it may move about the track 115 along an axis that intersects the axis the track 115 moves about the frame 110. In a preferred embodiment, the drive 125 comprises an electric engine or and pneumatic/hydraulic device, but one with skill in the art will recognize that other types of engines/devices may be used by the system as a drive 125 without departing from the inventive subject matter described herein.

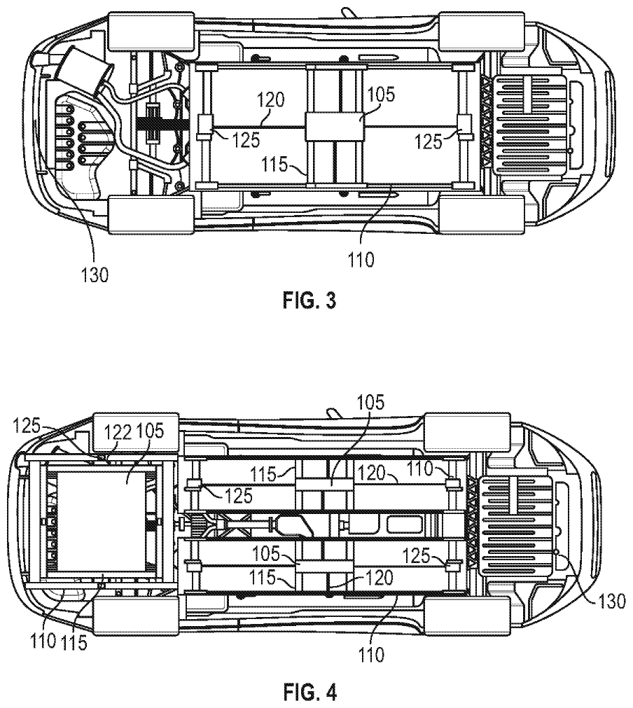

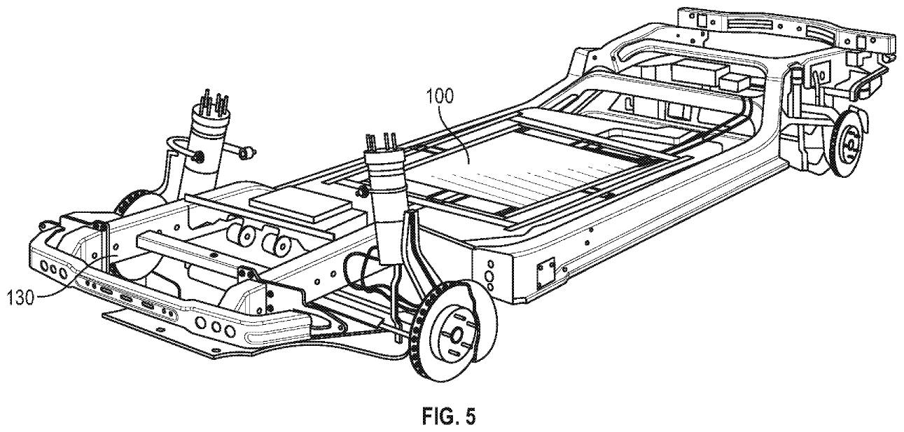

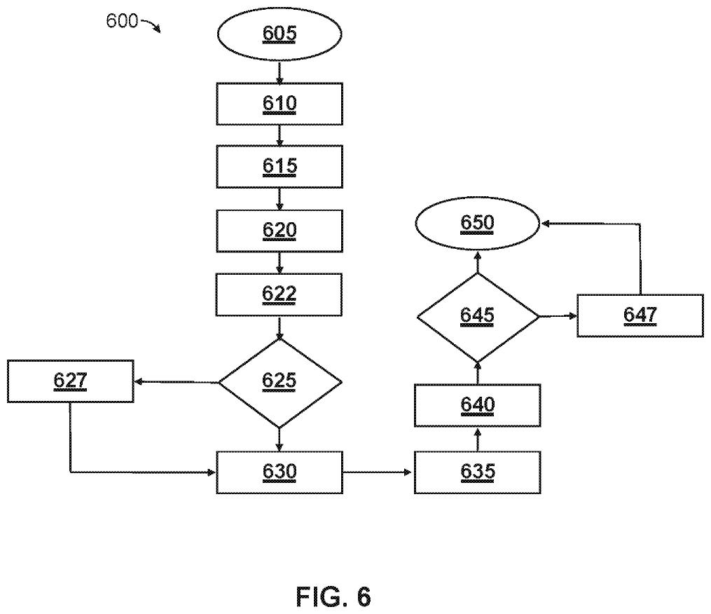

Although the system 100 and method of the present disclosure have been discussed for use within the automotive field, one of skill in the art will appreciate that the inventive subject matter disclosed herein may be utilized in other fields or for other applications in which altering weight distribution to increase efficiency, performance, and safety may be needed. Vehicles 130 in which the system 100 may be used to alter the center of gravity by adjusting the positioning of the batteries within the vehicle include, but are not limited to, cars, trucks, trains, airplanes, helicopters, motorcycles, dirt bikes, golf carts, all-terrain vehicles, farm equipment, cranes, and boats. For instance, the system 100 could be used in the hulls of boats having electric motors and large batteries 105. The system 100 may shift the position of the batteries 105 within the hulls to shift the boat's center of gravity, causing the boat to maintain a more balanced position while idle in waves. It is understood that the various method steps associated with the methods of the present disclosure may be carried out by a user using the system 100 shown in FIGS. 1-5. FIG. 1 illustrates a perspective view of the system 100 and its various components, wherein the drive 125 comprises an electric motor and cables 120. FIG. 2 illustrates a perspective view of the system 100 and its various components, wherein the drive 125 comprises a hydraulic/pneumatic device and struts 122. FIG. 3 illustrates a vehicle 130 having the embodiment of the system 100 illustrated in FIG. 1. FIG. 4 illustrates a vehicle comprising multiple systems 100 that may be used to alter the weight distribution of batteries within said vehicle 130, including the embodiments of FIG. 1 and FIG. 2. FIG. 5 illustrates how the embodiment of the system 100 of FIG. 2 may be disposed within the chassis of an electric vehicle 130. FIG. 6 illustrates a method a user may use to alter the position of the battery 105 within the chassis of an electric vehicle 130.

The frame 110 preferably comprises a plurality of rails configured to accept a track 115 and/or a drive 125. The preferred embodiment of a frame 110 comprises four circular rails connected to form a quadrilateral having four right angles, as illustrated in FIG. 1. In another preferred embodiment, the frame 110 comprises two rectangular rails that are configured to moveably attach to the track 115 via a strut 122, as illustrated in FIG. 2. The plurality of rails is preferably constructed of steel or aluminum, but one with skill in the art will recognize that other materials may be used without departing from the inventive subject matter herein. The track 115 is designed to fit within the shape created by the plurality of rails, wherein the shape of the preferred embodiment is a quadrilateral. In a preferred embodiment, the ends of the track 115 are moveably attached to the plurality of rails in a way that allows it to move about the frame 110, as illustrated in FIG. 1. The battery 105 sits within the track 115, and cables 120 attached to the battery 105 may apply a force on the battery 105 that causes the track 115 to move about the plurality of rails in the direction of said force. In a preferred embodiment, a pulling force is generated by a drive 125 operably connected to the cables 120. Alternatively, the system 100 may use drives 125 that use a hydraulic force to move the battery 105 about the shape of the frame 110.

In one embodiment, the track 115 comprises at least one support configured to accept a battery 105 thereon. In some embodiments, as illustrated in FIGS. 1, 3, and 4, the track 115 comprises four supports, wherein at least two sides of the track 115 created by said supports are slidably attached to the frame 110, allowing the track 115 to move about the plurality of rails as force is applied. The at least one support is preferably constructed of steel or aluminum, but one with skill in the art will recognize that other materials may be used without departing from the inventive subject matter herein. In one embodiment, the battery 105 is moveably attached to the plurality of rails in a way that allows it to move about said rail, as illustrated in FIG. 1. In one embodiment, the axis in which the battery 105 moves about the rail is perpendicular to the axis in which the track 115 moves about the frame 110, thus allowing the battery 105 to move freely within the shape created by the frame 110. Some preferred embodiments of a track 115 may further comprise a drive 125, which may be operably connected to the battery 105 via a cable 120 or strut 122.

The battery 105 may change positions within the shape of the frame 110 by way of the forces applied by the cables 120. In some embodiments, as illustrated in the embodiment of FIG. 3, the battery 105 within the track 115 is configured to move about a single axis. In another embodiment, as illustrated in the embodiment of FIG. 1, the battery 105 within the track 115 is configured to move about two axes. In yet another embodiment, as illustrated in the embodiment of FIGS. 2 and 4, the battery 105 within the track 115 is configured to move about three axes. In some preferred embodiments, the system 100 may alter the position of the battery 105 as the vehicle 130 is in motion. For instance, the system 100 may move the battery 105 closer to the front when a user is accelerating to allow more of the battery's 105 weight to be transferred to the front tires, thus increasing traction and allowing more energy push the vehicle 130 in the desired direction. In one preferred embodiment, the system 100 may alter the position of the batteries 105 within the vehicle in real time without the input of the user. For instance, when a user is braking, the system 100 may alter the position of the battery 105 closer to the rear of the vehicle 130 in order to distribute the vehicle's 130 weight across all the wheels more evenly, allowing for all the brakes to contribute equally to slowing the vehicle 130. This position or other positions may also be used to increase efficiency, performance, safety, and the benefits of any regenerative braking within a vehicle 130. For instance, when a user is cornering the vehicle 130, the system 100 could change the position the battery 105 to counteract the centrifugal force and other forces acting upon a vehicle 130. By moving the battery 105 left while turning left or right while turning right, the friction and grip of the tires on the road would be increased, which would increase the overall performance and handling of the vehicle 130. Therefore, by altering the position of the battery 105 within the shape created by the frame 110 along X, Y, and Z axes, as illustrated in FIGS. 2 and 4, the system 100 can increase performance of a vehicle 130 in real time.

In one embodiment, the drive 125 comprises a motor, gear train, and drum. In some embodiments, the drive 125 may be moveably attached to the frame 110 such that it may move about the frame 110. In some preferred embodiments, multiple drives 125 may be attached to the frame 110 so that they may work together to move that battery 105 about the shape created by said frame 110. In some embodiments, at least one cable 120 is attached to the drum in a way such that it may wind around the drum. The motor may turn the drum about a central axis, which may cause the cable 120 to spool or unspool from the drum. In one embodiment, the cables 120 are attached to the battery 105 along the axes, which may allow the drives 125 to pull the battery 105 to a desired position relative the frame 110. In an embodiment, the motor is an electric motor having an armature and a stator. The armature may be defined as rotor having a magnetic field that may be used to generate torque, and the stator may be defined as an outer set of permanent magnets or field coils that interact with the magnetic field of the armature to generate torque. By altering the magnetic field of the stator, the armature rotates in a way that produces the aforementioned torque.

In one embodiment, the electric motor is a permanent magnet motor or series wound motor, wherein the stator of the permanent magnet motor uses magnets to alter the magnetic field and the stator of the series wound motor uses field coils to alter the magnetic field. The armature may be operably connected to the gear train in a way such that torque generated by the motor is transferred to the gear train. The gear train comprises a plurality of gears and a housing, wherein the plurality of gears is operably connected to the motor and drum in a way such that the rotation rate of the motor is geared down to a slower rotation rate with higher torque, which is then applied to the drum. Types of gears that may act as the gear train include, but are not limited to, planetary gears, worm gears, and spur gears, or any combination thereof. For instance, the system 100 may comprise a drive 125 having worm gears applying force to the battery 105 about the y-axis and planetary gears applying force to the batter about the x-axis. The drum is operably connected to the gear train in a way such that the torque generates by the gear train is transferred to the drum. As the drum spins about a central axis, the cable 120 is spooled or unspooled about the drum. In a preferred embodiment, the diameter of the drum is as large as possible to reduce the loss in pulling force as the cable spools around the drum.

Alternatively, the drive 125 may comprise a pneumatic device or hydraulic device. The pneumatic/hydraulic device may comprise a pump, fluid, reservoir, control valves, an actuator connected to the pump via a plurality of tubes, and a plurality of seals. The pump supplies the fluid to the various components of the hydraulic/pneumatic device. The control valves direct the fluid to various locations of the hydraulic/pneumatic device via the plurality of tubes. In a preferred embodiment, a computing device is operably connected to the control valves in a way such that a user may operate the computing device in a way that instructs the control valve which route through the plurality of tubes the fluid may take to the actuator. The actuator is responsible for moving objects using the work force generated by the pressure changes caused by the fluid. The reservoir holds fluid, which may be a liquid or gas, not currently being used to operate the hydraulic/pneumatic device. The plurality of seals prevents the escape of fluid from the hydraulic/pneumatic device.

In one embodiment, the actuator further comprises a hydraulic/pneumatic cylinder defined by an internal cavity, a slidably moveable piston disposed within the internal cavity, and a strut 122 operably connected to the slidably moveable piston. The slidably moveable piston may be shaped in a way such that it creates two chambers within the cavity. In a preferred embodiment, the hydraulic/pneumatic cylinder may be operably connected to the actuator in a way such that the computing device manipulates the control valve so that it directs fluid pumped by the pump into one of a first chamber or a second chamber of the hydraulic/pneumatic cylinder. Pressure change resulting from fluid being injected into the first chamber or second chamber acts on the slidably moveable piston, causing the slidably moveable piston to move in a direction from higher pressure to lower pressure. The strut 122 is projected out the strut end of the hydraulic/pneumatic device and is coupled to the track 115 in a way such that it may move the track 115 about the frame 110. In other preferred embodiments, the strut 122 may be coupled to the battery 105 in a way such that it may move the battery 105 about the track 115. Operating the hydraulic/pneumatic device to cause the slidably moveable piston to move in a direction from higher pressure to lower pressure causes the strut 122 to move in a linear direction, which in turn causes the track 115 and/or battery 105 change locations and/or positions. For instance, a plurality of hydraulic/pneumatic devices may be attached to the track 115 and battery 105 in a way such that a user may change the center of gravity in a vehicle 130 be moving the batteries 105 along the X, Y, and Z planes within the shape created by the frame 110, as illustrated in FIG. 2.

The processor is configured to perform the operations disclosed herein based on instructions stored within the system 100. The processor may process instructions for execution within computing device, including instructions stored in memory or on a storage device, to display graphical information for a graphical user interface (GUI) on an external input/output device, such as a display. The processor may provide for coordination of the other components of a computing device, such as control of user interfaces, applications run by a computing device, and wireless communication by a communication device of the computing device. The processor may be any processor or microprocessor suitable for executing instructions. In some embodiments, the processor may have a memory device therein or coupled thereto suitable for storing position data or other information or material disclosed herein. In some instances, the processor may be a component of a larger computing device. A computing device that may house the processor therein may include, but are not limited to, laptops, desktops, workstations, personal digital assistants, servers, databases, mainframes 110, cellular telephones, tablet computers, or any other similar device. Accordingly, the inventive subject matter disclosed herein, in full or in part, may be implemented or utilized in devices including, but are not limited to, laptops, desktops, workstations, personal digital assistants, servers, databases, mainframes 110, cellular telephones, tablet computers, or any other similar device.

In an embodiment, the programming instructions responsible for the operations carried out by the processor are stored on a non-transitory computer-readable medium (“CRM”), which may be coupled to the processor. Alternatively, the programming instructions may be stored or included within the processor. Examples of non-transitory computer-readable mediums include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions may be stored as modules within the non-transitory computer-readable medium. In a preferred embodiment, position data is stored on the computer readable medium, which may comprise coordinates that allow the processor to control the drives 125 of the system 100 to change the position of the battery 105 within the shape of the frame 110.

In some embodiments, the system 100 may comprise instructions that allow the processor to use geospatial data to calculate position data that may be used by the system 100 to alter the position of the batteries 105 within the vehicle 130. For instance, the system 100 may convert geospatial data obtained by a global positioning system (GPS) into a geolocation, which the system 100 may then use to determine a vehicle's 130 position on a map of a geographic information system (GIS), wherein said map contains elevation data and roadway profiles that may indicate to the system 100 upcoming terrain features that may require the vehicle 130 to have an altered center of gravity. The system 100 may then use the information pertaining to elevation changes and roadway profiles to calculate position data, which the system 100 may use to alter the position of batteries 105 within the vehicle 130 in real time in order to increase the driving performance, efficiency, and safety of the vehicle 130.

In other embodiments, the system 100 may use artificial intelligence (AI) techniques to adjust the position of the batteries 105 within a vehicle 130. The term “artificial intelligence” and grammatical equivalents thereof are used herein to mean a method used by the system 100 to correctly interpret and learn from data of the system 100 or a fleet of systems 100 in order to achieve specific goals and tasks through flexible adaptation. Types of AI that may be used by the system 100 include, but are not limited to, machine learning, neural network, computer vision, or any combination thereof. The system 100 preferably uses machine learning techniques to learn what position the batteries 105 should be placed under certain circumstances, wherein the instructions carried out by the processor for said machine learning techniques are stored on the CRM. Machine learning techniques that may be used by the system 100 include, but are not limited to, regression, classification, clustering, dimensionality reduction, ensemble, deep learning, transfer learning, reinforcement learning, or any combination thereof.

The system 100 may use more than one machine learning technique to determine the best position of the batteries 105 within the shape of the frame 110. For instance, the system 100 may use a combination of clustering a reinforcement learning to learn the user's preferred driving style and the most effective position for the batteries 105 based on said preferred driving style. Machine learning techniques may also be used to as assist users of a vehicle 130 having the system 100 in making a choice in how to position the batteries 105 within the vehicle 130. For instance, the system 100 may use supervised deep learning combined with results from computer-aided detection to instruct a user that in rainy conditions the batteries 105 should be placed in a position that increases weight over the drive train and/or brakes of the vehicle 130 to increase friction on those tires. Over time, the system 100 may obtain more knowledge about a driver's driving style, vehicle 130 weight distribution, and environmental conditions of the environment in which the user operates the vehicle 130, allowing it to make more intelligent decisions about how to best enhance a user's driving experience.

In an embodiment, the system 100 may further comprise a computing device operably connected to the processor. A computing device may be implemented in a number of different forms, including, but not limited to, servers, multipurpose computers, mobile computers, etc. For instance, a computing device may be implemented in a multipurpose computer that acts as a personal computer for a user, such as a laptop computer. For instance, components from a computing device may be combined in a way such that a mobile computing device is created, such as mobile phone. Additionally, a computingdevice may be made up of a single computer or multiple computers working together over a network. For instance, a computing device may be implemented as a single server or as a group of servers working together over and Local Area Network (LAN), such as a rack server system. Computing devices may communicate via a wired or wireless connection. For instance, wireless communication may occur using a Bluetooth, Wi-Fi, cellular networks (LTE, 3G, 4G, 5G, etc.), or other such wireless communication devices. In a preferred embodiment, the computing device may be a proportional, integral, derivative (PID) controller, which may allow the system 100 to continuously calculate the position of the batteries 105 based on information received by the system 100.

Some embodiments of the system 100 may use at least one sensor to measure environmental conditions a vehicle 130 is experiencing, wherein said at least one sensor may transmit said environmental data to the processor. An environmental condition may be defined as external conditions experienced by a vehicle 130. Types of sensors that may be used as an at least one sensor include, but are not limited to, a microphone, camera, turbidity sensor, thermometer, humidity sensor, passive infrared sensor, light sensor, lightning sensor, wind transducer, compass, GPS, gyroscope, accelerometer, barometer, crash sensor, proximity sensor, radar, ultrasonic sensors, or any combination thereof. Therefore, the at least one sensor may measure a variety of types of environmental data and transmit that data to the processor and/or computing device. For instance, a system 100 comprising a gyroscope, accelerometer, humidity sensor, and wind transducer may collect angular velocity data, acceleration data, humidity data, and wind speed data and transmit that data to a PID controller, which the system 100 may then use to constantly adjust the position of the batteries 105 within the system 100 via the drives 125. The system 100 may further comprise a camera and an AI technique designed to analyze the image data captured by the camera. Should the AI technique determine that a crash is imminent based on the image data, the AI technique may override the PID controller and cause the drives 125 to shift the batteries 105 to a safer position prior to the crash, which may protect the battery 105 cells from damage and a subsequent explosion.

Once the processor has received the environmental data, the processor may analyze the data and alter the position of the batteries 105 to increase the efficiency, performance, and safety of a vehicle 130 in real time. For instance, a crash sensor configured to detect when a vehicle 130 is about to roll over may provide the system 100 with environmental data that causes the system 100 to shift the batteries 105 in a way that prevents the vehicle 130 from rolling over. For instance, a plane having a barometer and gyroscope indicating that said plane is about to crash may shift the batteries 105 just prior to impact to reduce the angle in which plane makes impact with the ground/water. In some preferred embodiments, environmental data may be saved by the system 100 so that it may be analyzed at a later time. For instance, the system 100 may use machine learning techniques to better understand a user's driving style during certain weather events so that it may later adjust the position of the batteries 105 in a way that most enhances a user's driving experience. For instance, a train fitted with a GPS device may cause the drive 125 to shift the batteries 105 to a position that assists the train with braking as it nears a geolocation in which the train is supposed to stop.

Some embodiments of the system 100 may comprise a geolocation device. The geolocation device may be a single component of a larger computing device. In one preferred embodiment, the geolocation device may comprise a plurality of devices working together to obtain a geolocation via triangulation. In a preferred embodiment, the geolocation device is a GPS sensor. The GPS sensor may measure and transmit geospatial data relevant for determining geolocation. A GPS sensor may be defined as a receiver having an antenna designed to communicate with a navigation satellite system. Geospatial data may be spatial data including, but not limited to, numeric data, vector data, and raster data, or any combination thereof. Numeric data may be statistical data which includes a geographical component or field that can be joined with vector files so the data may be queried and displayed as a layer on a map in a GIS. Vector data may be data that has a spatial component, or X, Y coordinates assigned to it. Vector data may contain sets of points, lines, or polygons that are referenced in a geographic space. Raster data may be data in a .JPG, .TIF, .GIF or other picture file format. For instance, a map scanned in a flatbed scanner may be considered raster data.

In an embodiment, the system 100 may further comprise a user interface. A user interface may be defined as a space where interactions between a user and the system 100 may take place. In a preferred embodiment, the interactions may take place in a way such that a user may control the operations of the system 100, and more specifically, allow a user to control the position of the batteries 105 about the frame 110. A user may input instructions to control operations of the system 100 manually using an input device. For instance, a user may choose to alter the position of the batteries 105 within the vehicle 130 to increase braking and/or acceleration performance by pressing buttons within the console of the vehicle 130 or by way of a touchscreen built into the dashboard of the vehicle 130. A user interface may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, tangible user interfaces, or any combination thereof.

A display may be defined as an output device that communicates data that may include, but is not limited to, visual, auditory, cutaneous, or any combination thereof. Information presented via a display may be referred to as a soft copy of the information because the information exists electronically and is presented for a temporary period of time. Information stored on the non-transitory computer-readable medium may be referred to as the hard copy of the information. For instance, a display may present a soft copy of a visual representation of the position of the batteries 105 within a vehicle 130 via a liquid crystal display (LCD), wherein the hardcopy of the visual representation of the position of the batteries 105 within the vehicle 130 may be stored on a local hard drive. For instance, a display may present a soft copy of audio information via a speaker that informs the user that the batteries 105 have been placed into a position to increase the efficiency, performance, and safety of the vehicle 130, wherein the hard copy of the audio information is stored on in the memory. Displays may include, but are not limited to, LCD monitors, light emitting diode (LED) monitors, gas plasma monitors, screen readers, speech synthesizers, speakers, or any combination thereof, but is not limited to these devices.

FIG. 6 provides a flow chart 600 illustrating certain, preferred method steps that may be used to carry out the method of mobilizing the battery 105 of a vehicle 130. Step 605 indicates the beginning of the method. During step 610 the user may obtain a vehicle 130 having a system 100 attached thereto. Once obtained, the user may sit in the driver's seat during step 615 and subsequently turn on the vehicle 130 during step 620. Once turned on, the user may determine if they would like to adjust the position of the batteries 105 within the vehicle 130 during step 622. In one preferred embodiment, the user may adjust the position of the batteries 105 within the vehicle 130 using a user interface on a mobile computing device. In another preferred embodiment, a user may adjust the position of the batteries 105 within the vehicle 130 using a user interface of the vehicle 130, such as a tangible user interface or a touchscreen. Based on the results of the determination, a user may take an action during step 625. If the user determines that the position of the batteries 105 does not need to be changed, the user may proceed to step 630. If the user determines that the position of the batteries 105 within the vehicle 130 does need to be changed, the user may alter the position during step 627.

Once the position of the battery 105 has been changed, a user may begin driving the vehicle 130 during step 635. The user may then perform a query to determine if they would like to change the position of the batteries 105 within the vehicle 130 to alter the driving performance while driving during step 640. Based on the results of the determination, a user may take an action during step 645. If the user determines that the position of the batteries 105 does not need to be changed, the user may proceed to terminate method step 650. If the user determines that the position of the battery 105 within the vehicle 130 does need to be changed, the user may alter the position during step 647 until the desired driving performance has been reached. In embodiments of the system 100 having machine learning techniques, the system 100 may change the position of the batteries 105 and ask the user when a desired performance level has been reached while driving, thus eliminating steps 640 and 645. Once adjusted, the user may proceed to the terminate method step 650.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A system for mobilizing a battery of a vehicle comprising:
a frame;
a track operably connected to the frame;
a battery attached to the track; and,
a drive operably connected to the battery via a connection element, wherein the drive is configured to alter a position of the battery relative to the frame such that the vehicle's center of mass is altered in real time.

2. The system of claim 1, wherein the drive comprises an electric engine, a pneumatic device, or a hydraulic device.

3. The system of claim 1, wherein the connection element is a cable or strut.

4. The system of claim 1, further comprising:
at least one sensor configured to record and transmit environmental data;
a processor operably connected to the drive and the at least one sensor, wherein the processor is configured to calculate position data using the environmental data, wherein the processor is configured to direct the drive in a way that moves the battery to a position that coincides with the position data;
a computing device having instructions and operably connected to the processor, wherein said instructions contain position data that may be used to move the battery to the position; and,
wherein a user may choose the instructions using a user interface of the computing device.

5. The system of claim 1, wherein the vehicle is a car, a truck, a train, an airplane, a helicopter, a motorcycle, a bike, a utility vehicle, an all-terrain vehicle, a farm equipment vehicle, a crane, or a boat.

6. A system for mobilizing a battery of a vehicle comprising:
a frame;
a track operably connected to the frame, wherein the track is configured to move about the frame along a first axis;
a battery attached to the track such that the battery is configured to move along the first axis; and,
a drive operably connected to the battery via a connection element, wherein the drive is configured to alter a position of the battery relative to the frame along a second axis such that the vehicle's center of mass is altered in real time increasing the performance and handling of the vehicle.

7. The system of claim 6, wherein the second axis intersects the first axis.

8. The system of claim 7, wherein the second axis is perpendicular to the first axis.

9. The system of claim 6, wherein the drive comprises an electric engine, a pneumatic device, or a hydraulic device.

10. The system of claim 6, wherein the connection element is a cable or strut.

11. The system of claim 6, further comprising:
at least one sensor configured to record and transmit environmental data;
a processor operably connected to the drive and the at least one sensor, wherein the processor is configured to calculate position data using the environmental data, wherein the processor is configured to direct the drive in a way that moves the battery to a position that coincides with the position data;
a computing device having instructions and operably connected to the processor, wherein said instructions contain position data that may be used to move the battery to the position; and,
wherein a user may choose the instructions using a user interface of the computing device.

12. The system of claim 6, wherein the vehicle is a car, a truck, a train, an airplane, a helicopter, a motorcycles, a bike, a utility vehicle, an all-terrain vehicle, a farm equipment vehicle , a crane, or a boat.

13. A method for mobilizing a battery of a vehicle comprising steps:
(a) obtaining a vehicle having a battery mobilization device, the battery mobilization device having a frame, a track operably connected to the frame, a battery attached to the track, and a drive operably connected to the battery;
(b) determining a preferred position of the battery coinciding with a center of mass of the vehicle;
(c) changing a position of the battery within the frame using the drive until the preferred position of the battery is accomplished.
